(19) United States
(12) Patent Application Publication
(10) Pub. No.: US 2005/0287402 A1
(43) Pub. Date: Dec. 29, 2005

(54) AC impedance monitoring of fuel cell stack

(76) Inventors: Douglas K. Maly, Canton, MI (US); Bruce Lin, Vancouver (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/876,267

(22) Filed: Jun. 23, 2004

(51) Int. Cl. H01M 8/00

(52) U.S. Cl. 429/13; 700/286

(57) ABSTRACT

A ripple voltage, caused by a voltage inverter, is superimposed on an output voltage provided by a fuel cell stack. This ripple voltage is sensed and used to determine an AC impedance of the fuel cell stack. The determined AC impedance can be correlated to a hydration state of the fuel cell stack.

### TECHNICAL FIELD

The present disclosure relates generally to fuel cells, and in particular but not exclusively, relates to monitoring of an impedance of a fuel cell stack, such as a stack of solid polymer electrolyte fuel cells.

### BACKGROUND INFORMATION

Electrochemical fuel cell systems are being developed for use as power supplies in a number of applications, such as automobiles, stationary power plants, and other applications. Such fuel cell systems offer the promise of energy that is essentially pollution free, unlike conventional energy sources such as fossil fuel burning thermal power plants, nuclear reactors, and hydroelectric plants that all raise environmental issues.

Fuel cells convert reactants (fuel and oxidant) to generate electric power and reaction products (such as water). Fuel cells generally comprise an electrolyte disposed between cathode and anode electrodes. A catalyst induces the appropriate electrochemical reactions at the electrodes. The fuel cell may, for example, take the form of a solid polymer electrolyte fuel cell that comprises a solid polymer electrolyte and that operates at relatively low temperatures. During normal operation of a solid polymer electrolyte fuel cell, fuel is electrochemically oxidized at the anode catalyst, resulting in the generation of protons, electrons, and possibly other species. The protons are conducted from the reaction sites at which they are generated, through the electrolyte, to electrochemically react with the oxidant at the cathode catalyst.

Solid polymer electrolyte fuel cells generally employ a membrane electrode assembly (MEA) comprising a solid polymer electrolyte or ion exchange membrane disposed between the two electrodes. Typically, the electrolyte is bonded under heat and pressure to the electrodes, and thus such an MEA is dry as assembled.

To be sufficiently ion-conductive, the membrane electrolyte in a solid polymer fuel cell generally needs to be adequately hydrated. Since solid polymer electrolyte fuel cells are typically assembled in a dry state, the membrane electrolyte and other components of the fuel cell are hydrated as part of an activation process before electrical power producing operation can begin. While the electrochemical reactions during operation of the fuel cell generate water as a reaction by-product, this water typically is not distributed sufficiently to maintain adequate hydration over the entire electrolyte membrane. A hydrating process may also be needed if a previously operated fuel cell is allowed to dry out during prolonged storage or during operation. Canadian Patent Application Serial No. 2341140, entitled “METHOD FOR ACTIVATING SOLID POLYMER ELECTROLYTE FUEL CELLS,” published Sep. 24, 2001 discloses example techniques for activating a solid polymer fuel cell, including hydration of the fuel cell.

Conversely, excess water present in the fuel cell may cause flooding and thus be deleterious to efficient operation. Accordingly, there may also be times when drying of the stack is desired.

A sufficient assessment of the hydration state of a fuel cell stack is useful for humidification control, startup, shutdown, temperature control, and other operation of the fuel cell stack. However, the hydration state of the fuel cell stack is difficult to assess simply from its polarization response.

The resistance of the fuel cell stack is known to be correlated to the hydration of its electrolyte membranes. As demonstrated in further detail in Canadian Application Serial No. 2341140, the impedance of a dry fuel cell is greater than that of a hydrated cell. At an appropriate frequency, the real component of AC impedance (resistance) is highly influenced by effects of the electrolyte membrane, and a higher resistance corresponds to a drier membrane, which is less able to conduct protons as compared to a better-hydrated membrane.

While AC impedance is a good indicator of membrane hydration, measurement of AC impedance is difficult and time consuming. Existing milliohm meters are too expensive and too bulky to package into an end user's fuel cell system or vehicle, for example. Other techniques for determining fuel cell membrane hydration, to a limited extent and with significant measuring effort, involves analyzing media (gases and liquids) that are supplied to and/or discharged from the fuel cell or involves use of additional suitable sensors. Using such analysis equipment requires significantly more space in a fuel cell system and only has limited suitability for vehicles. Moreover, the information derived using these techniques is provided with a time delay, which is a disadvantage for situations that require a more up to date determination of the AC impedance.

In a standard method for measuring the impedance spectrum of a fuel cell (test specimen) at the manufacturing stage, a frequency generator applies a sinusoidal current to the fuel cell stack. The voltage is measured, and from the applied current and the measured voltage, the impedance can be determined. The frequency of the applied current is subsequently increased (or decreased) for the next measurement. Measurement of the impedance at a number of frequencies produces the impedance spectrum.

Disadvantages of this method include the requirements for a frequency generator, repetitive measurements of current and voltage at different frequencies, and costly evaluation electronics. This analysis equipment ultimately adds significant expense to the overall fuel cell system, either or both at the manufacturing and testing stages prior to shipment to the user and/or at the user end. Therefore, packaging impedance spectra measuring equipment for this method into a fuel cell system (whether used for transportation or other fuel cell implementation) is difficult and impractical.

### BRIEF SUMMARY OF THE INVENTION

According to one aspect, a method comprises obtaining a value of a ripple voltage caused at least in part by a power transformation device. The ripple voltage is superimposed on an output voltage provided from a fuel cell stack coupled to the power transformation device. The method uses the obtained value of the ripple voltage to determine a characteristic associated with at least one fuel cell in the fuel cell stack, and determines a hydration state of the at least one fuel cell in the fuel cell stack based on the determined characteristic.

According to another aspect, an article of manufacture comprises a machine-readable medium for a system comprising a power transformation device and at least one fuel cell in a fuel cell stack coupled to the power transformation device. The machine-readable medium comprises instructions stored thereon to cause a processor to determine a characteristic associated with the at least one fuel cell, by: obtaining a value of a ripple voltage caused at least in part by the power transformation device, the ripple voltage being superimposed on an output voltage provided from the fuel cell stack coupled; and using the obtained value of the ripple voltage to determine the characteristic associated with the at least one fuel cell in the fuel cell stack.

According to still another aspect, a system comprises means for obtaining a value of a ripple voltage superimposed on an output voltage provided by an energy device. The system comprises a means for using the obtained value of the ripple voltage to determine a characteristic associated with the energy device, and comprises means for determining a hydration state of the energy device based on the determined characteristic.

According to yet another aspect, an apparatus comprises a sensor to sense a ripple signal superimposed on an output from an energy device. Circuitry coupled to the sensor generates a value indicative of the sensed ripple signal, and a controller coupled to the circuitry determines a characteristic of the energy device based on the value indicative of the sensed ripple signal.

### BRIEF DESCRIPTION OF THE SEVERAL VIEWS OF THE DRAWINGS

Non-limiting and non-exhaustive embodiments are described with reference to the following figures, wherein like reference numerals refer to like parts throughout the various views unless otherwise specified.

FIG. 1 is a schematic block diagram of an embodiment of a fuel cell in a fuel cell stack.

FIG. 2 is a block diagram of a fuel cell system in which an AC impedance of the fuel cell stack of FIG. 1 may be monitored in accordance with an embodiment.

FIG. 3 are graphs illustrating ripple in voltage and current from the fuel cell stack of FIG. 1.

FIG. 4 is a flowchart of an embodiment of a method to monitor AC impedance of the fuel cell stack for the system of FIG. 2.

### DETAILED DESCRIPTION

Embodiments of techniques to monitor an impedance of a fuel stack and to use the monitored impedance to determine a hydration state of the fuel stack are described herein. In the following description, numerous specific details are given to provide a thorough understanding of embodiments. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the claimed invention. Furthermore, certain figures herein depict various voltage and current waveforms. These waveforms are intended to be illustrative for purposes of understanding operation of embodiments, and are not intended to be drawn to scale and/or to precisely and accurately depict waveform behavior in terms of shape, amplitude, duty cycle, frequency, distortion, or other characteristics.

As an overview, an embodiment monitors an AC impedance of a fuel cell stack. In a system that comprises a fuel cell stack, electronic components (such as a voltage inverter) in the system produce a ripple in the output DC voltage provided by the fuel cell stack. The AC impedance is obtained from this voltage isolation by an embodiment, thereby exploiting a generally parasitic phenomenon to obtain useful information indicative of the AC impedance of the fuel cell stack.

The impedance of a fuel cell stack at certain frequencies can be correlated to the hydration of its membranes. With this knowledge of the hydration of the fuel cell stack, operating conditions can be varied to control flooding and membrane drying. Shut down purges can be tuned to avoid overdrying the MEAs, while still allowing removal of excess water. Knowledge of the hydration state also allows humidification to be optimized during startups.

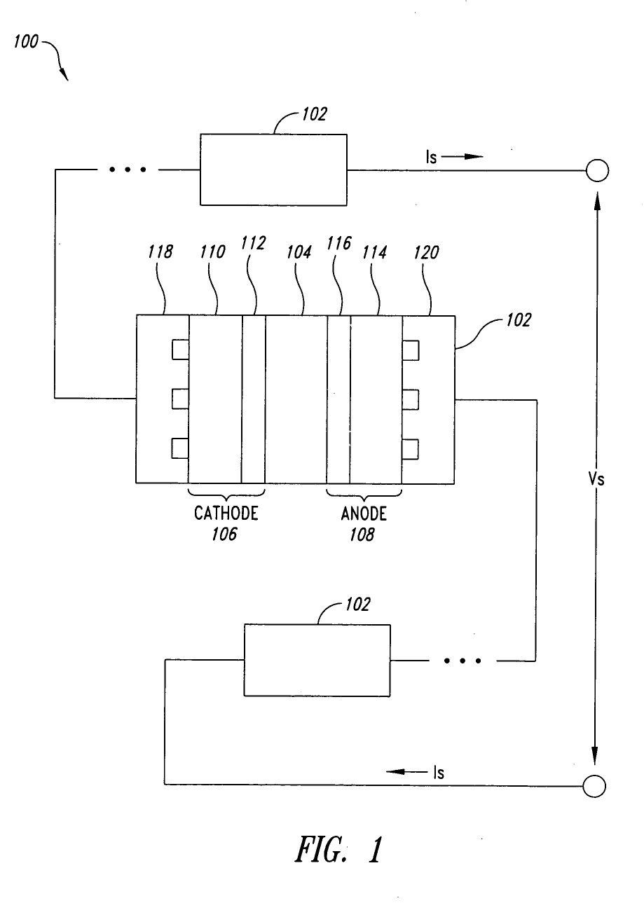

FIG. 1 is a schematic block diagram of an embodiment of a fuel cell stack 100. The fuel cell stack 100 comprises at least one fuel cell 102, only one of which is shown in detail in FIG. 1 for the sake of simplicity. The fuel cells 102 individually generate a voltage and are coupled in series to provide a higher overall DC output voltage Vs from output terminals of the fuel stack 100. A current is, common to all of the fuel cells 102, is provided as output current by the fuel cell stack 100. In an example embodiment, the fuel cell stack 100 comprises 4 rows of fuel cells 102, with 100 fuel cells in each row.

According to an embodiment, each fuel cell 102 is a solid polymer electrolyte fuel cell. The fuel cell 102 of such an embodiment comprises a membrane electrode assembly (MEA), which itself comprises a solid polymer electrolyte membrane 104 disposed between a cathode 106 and an anode 108. The cathode 106 comprises a porous substrate 110 and a catalyst layer 112. The anode 108 comprises a porous substrate 114 and a catalyst layer 116. The fuel cell 102 further comprises field plates 118 and 120 with inlet ports (not shown) to receive oxidant and fuel, and with outlet ports (not shown) for oxidant and fuel exhaust. According to an embodiment, one or more inlet ports of the fuel cell 102 can be used to receive steam or water for hydration purposes during startup, operation, shutdown, storage, etc. as needed.

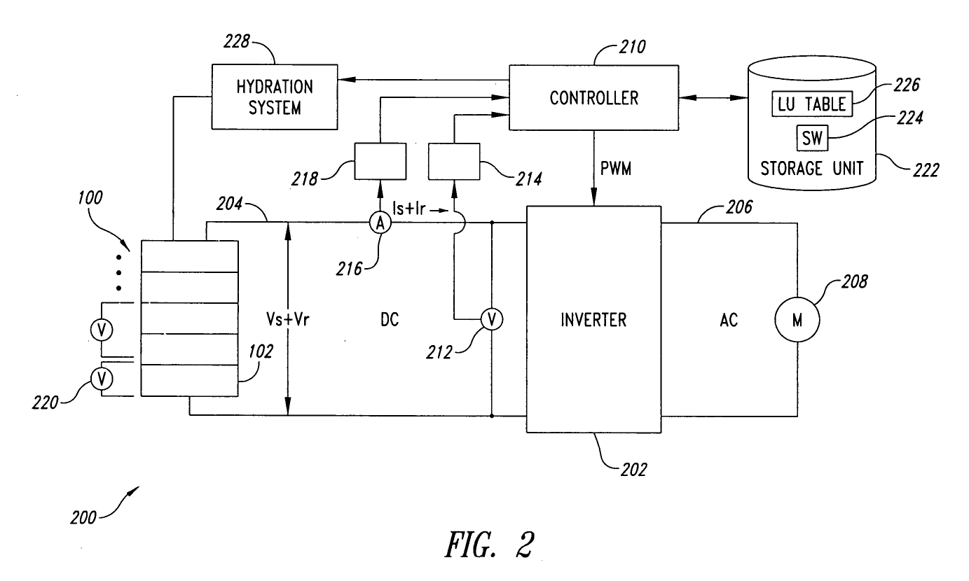

FIG. 2 is a block diagram of an example fuel cell system 200 that comprises the fuel cell stack 100 of FIG. 1 and which further comprises components for monitoring AC impedance of the fuel cell stack 100 in accordance with an embodiment. For purposes of clarity and simplicity of explanation, not all of the possible components present in the fuel cell system 200 (such as filters, switches, fuses, signal processing equipment, or other electrical or mechanical components) are shown and described herein. Only the components useful for understanding operation of an embodiment are shown and described.

In the fuel cell system 200, the fuel cell stack 100 (comprising a plurality of individual fuel cells 102) is coupled to an inverter 202. The fuel cell stack 100 provides DC signals to the inverter 202 by way of a DC bus 204. The inverter 202 is coupled via an AC bus 206 to a load 208. The inverter 202 inverts the incoming DC signals into AC signals that supply AC power to the load 208. Purely by way of example, the load 208 in FIG. 2 is depicted as an electric drive motor, which can comprise part of an integrated powertrain for a vehicle. It is appreciated that other types of electrical loads may be supplied with AC power by the fuel cell system 200. Moreover, it is appreciated that the buses 204 or 206 can be unidirectional or bidirectional.

The inverter 202 contains circuitry and/or logic appropriate to extract DC power from the fuel cell stack 100 (five fuel cells 102 being shown in FIG. 1 as an example), invert the extracted DC power to AC power, and export the AC power to the load 208. The inverter 202 of one embodiment comprises a plurality of switches, such as six insulated gate bipolar transistors (IGBTs) that comprise pairs of switches for a 3-phase inverter. In one embodiment, the inverter 202 comprises a voltage source inverter working in current control mode. One possible example embodiment of the inverter 202 is described in U.S. patent application Ser. No. 10/447,708, entitled “METHOD AND APPARATUS FOR MEASURING FAULT DIAGNOSTICS ON INSULATED GATE BIPOLAR TRANSISTOR CONVERTER CIRCUITS,” filed May 28, 2003, and incorporated herein by reference in its entirety. Other example embodiments for the inverter 202 are disclosed in other issued patents and published applications owned by the assignee of the present application.

A controller 210 (such as one or more microcontrollers, microprocessors, or other processor) controls the switching and other associated operations of the inverter 202. In one embodiment, the controller 210 provides pulse width modulation (PWM) control signals to the inverter 202 to control operation of the switches therein. For example, the PWM control signals from the controller 210 (applied to control gates of the switches) can control the switching frequency of the inverter 202 to be at 5 kHz-8 kHz (or higher/lower).

Due to the nature of the switching operation, non-linearities in the components in the inverter 202, and/or other contributing factors, an AC ripple voltage (Vr), at the switching frequency of the inverter 202 or harmonics of that switching frequency (i.e., at a higher multiple of the fundamental switching frequency), is produced. This AC ripple voltage Vr is superimposed on the DC output voltage Vs provided by the fuel cell stack 100, thereby resulting in an output voltage from the fuel cell stack 100 on the DC bus 204 that is not entirely DC in nature (e.g., an output voltage Vs+Vr labeled in FIG. 2 that has both DC and AC components). An AC ripple may also appear in the current Is that is output from the fuel cell stack 100.

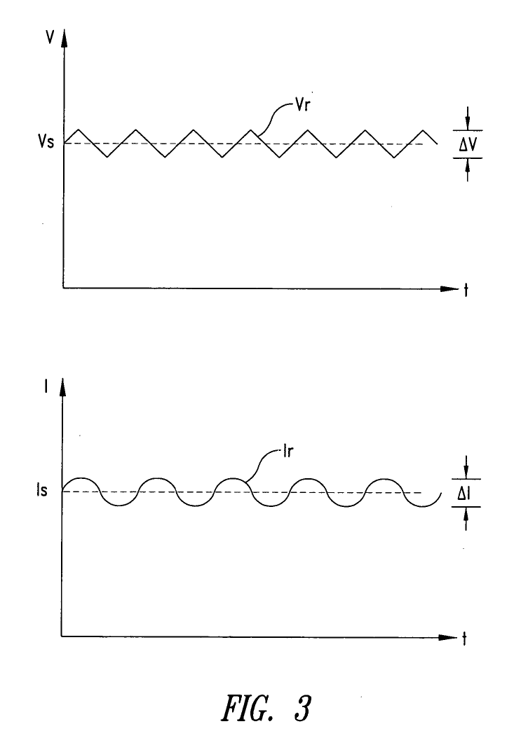

FIG. 3 is a graphical representation of the AC ripple voltage Vr superimposed on the DC output voltage Vs, as well as a graphical representation of an AC ripple current Ir superimposed on the output current Is. In the example embodiment of FIG. 3, the AC ripple voltage Vr is a triangular/sawtooth waveform with a peak-to-peak value of ΔV. In other embodiments, the AC ripple voltage Vr can comprise other forms, such as square wave, rectangular wave, sinusoidal, or other periodic waveform. An example frequency of the AC ripple voltage Vr is 8 kHz or more (or other frequency consistent with the switching frequency of the inverter 202), and an example peak-to-peak value of ΔV is in the order of millivolts.

With respect to the graphical representation of current in FIG. 3, the AC ripple current Ir is depicted as a generally sinusoidal waveform, with a peak-to-peak value of ΔI. Again, it is understood that the AC ripple current ir can comprise various possible forms, such as square wave, rectangular wave, sinusoidal, or other periodic waveform. The AC ripple current Ir of one embodiment can comprise substantially the same frequency as the AC ripple voltage Vr, but can comprise a peak-to-peak value of value of ΔI that is substantially larger in magnitude relative to the value of ΔV when full rated voltage is provided to the load 208. Accordingly and in a manner that will be described below, high resolution for the AC impedance of the fuel cell stack 100 can be calculated or otherwise obtained based on the value of the AC ripple voltage Vr divided by the AC ripple current Ir.

The output current Is and the output voltage Vs are both depicted in FIG. 3 as comprising a substantially constant DC value. In other embodiments, either or both the output current is and the output voltage Vs can comprise periodic or non-periodic forms that are not necessarily DC in nature. In such other embodiments, the output current Is and the output voltage Vs may still comprise the AC ripple current Ir and the AC ripple voltage Vr superimposed thereon, respectively.

With reference back to FIG. 2, the output voltage Vs comprising the AC ripple voltage Vr superimposed thereon can be detected by a voltage sensor 212 coupled across the DC bus 204. Conditioning circuitry 214 may be coupled between the voltage sensor 212 and the controller 210 to provide detected voltages from the voltage sensor 212 in a format that can be interpreted by the controller 210. For example, the conditioning circuitry 214 can comprise filters, an amplifier, analog-to-digital converter, samplers, or other electronic circuitry.

In one embodiment, the voltage sensor 212 can comprise or may otherwise be coupled to a capacitor (or other suitable DC-blocking element) to remove the output voltage Vs, which therefore allows the voltage sensor 212 to sense the values for the AC ripple voltage Vr. According to various embodiments, the sensed values for the AC ripple voltage Vr can be the peak-to-peak value ΔV, an instantaneous value of Vr, an amplitude of Vr, a root mean square (RMS) value of Vr, an averaged value of Vr, or other type of value of Vr or combination thereof. These sensed values are provided to the conditioning circuitry 214, which can then convert the sensed voltage values into signals, such as digital signals, for the controller 210.

A current sensor 216 can also be coupled to the DC bus 204, in series between the fuel cell stack 100 and the inverter 202, to sense the output current Is, which may comprise the AC ripple current Ir superimposed thereon. In a manner analogous to the conditioning circuitry 214, conditioning circuitry 218 may be coupled between the current sensor 216 and the controller 210 to provide detected currents from the current sensor 216 in a format that can be interpreted by the controller 210. For example, the conditioning circuitry 218 can comprise filters, an amplifier, analog-to-digital converter, samplers, or other electronic circuitry.

As with the voltage sensor 212, the current sensor 216 of one embodiment can comprise or may otherwise be coupled to a capacitor (or other suitable DC-blocking element) to block the output voltage Is, which therefore allows the current sensor 216 to sense the isolated values for the AC ripple current Ir. According to various embodiments, the sensed values for the AC ripple current Ir can be the peak-to-peak value ΔI, an instantaneous value of Ir, an amplitude of Ir, a root mean square (RMS) value of Ir, an averaged value of Ir, or other type of value of Ir or combination thereof. These sensed values are provided to the conditioning circuitry 218, which can then convert the sensed current values into signals, such as digital signals, for the controller 210.

In the embodiments thus described, both the voltage sensor 212 and the current sensor 216 sense voltages and currents, respectively, that are averaged or otherwise combined from all of the fuel cells 102 in the fuel cell stack 100. In another embodiment, separate individual voltage sensors 220 can be coupled across individual fuel cells 102 and/or to any combination of the fuel cells 102, so as to obtain the AC voltage ripple contribution attributable to each individual fuel cell 102 (and/or attributable to any combination of fuel cells 102). Since the current output from each fuel cell 102 is the same and given the separately determined values of the AC ripple voltage Vr attributable to individual and/or combination of fuel cells 102, the AC impedance of single ones and/or combination of fuel cells 102 can be obtained.

The controller 210 is coupled to a storage unit 222 or other machine-readable storage medium. In an embodiment, the storage unit 222 comprises software 224 that is executable by the controller 210 for determining the AC impedance of the fuel cell stack 100. For example in one embodiment, given the sensed values for Vr and Ir, the controller 210 can cooperate with the software 222 to determine the AC impedance using the formula Z=ΔV/ΔI or other computation for the real-time instantaneous AC impedance that can be derived from values of the ripple voltage and current.

In another example embodiment, the controller 210 can access a lookup table 226 to determine the AC impedance. The lookup table 226 of one embodiment can comprise entries of representative AC voltage ripple Vr magnitudes, peak-to-peak amplitudes, instantaneous values, RMS values, averaged values, and/or other values or combinations thereof. For each of these Vr values, representative AC ripple current values can also be provided as entries in the lookup table 226, along with resulting AC impedance Z values for each current and voltage pair. Thus, the AC impedance Z need not be explicitly calculated, but can be obtained directly from an entry in the lookup table 226.

Several possible techniques may be used to populate the lookup table 226. According to one embodiment, during the manufacturing stage, values of the AC ripple voltage Vr and the AC ripple current Ir can be sensed for different levels of hydration of the fuel cell stack 100, and then programmed into the lookup table 226. This technique thus provides accurate baseline values of voltage, current, and AC impedance for the lookup table 226 that are based on actual hydration conditions, and which can later be used for comparison with real-time sensed values of the AC ripple voltage and AC ripple current when in situ determination of the AC impedance of the fuel cell stack 100 is performed during regular operation.

The controller 210 may be coupled to a hydration system 228. The hydration system 228 is responsive to the controller 210 to hydrate or dehydrate the fuel cell stack 100 (and/or individual fuel cells 102 therein). For example, the lookup table 226 can contain entries indicative of hydration amounts (e.g., relative humidity, volume, time, flow rate, pressure, etc.) that need to be added by the hydration system 228 to the fuel cell stack 100 in response to certain determined AC impedance values. The controller 210 can then control the amount of hydration provided by the hydration system 228 based on the hydration entries indicated in the lookup table 226, so as to obtain a desired level of hydration in the fuel cell stack 100.

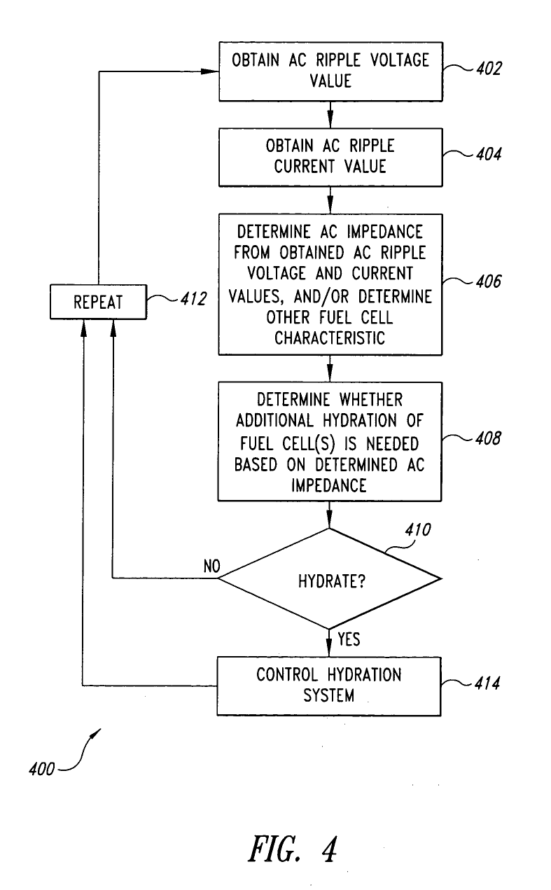

FIG. 4 is a flowchart of a method 400 for determining AC impedance of the fuel cell stack 100 (and/or AC impedance of individual fuel cells 102 or groups of fuel cells 102). Elements of one embodiment of the method 400 may be implemented in software or other machine-readable instruction stored on a machine-readable medium, such as the software 224 in the storage unit 222. The various operations depicted in the method 400 need not occur in the exact order shown. Moreover, certain operations can be modified, added, removed, combined, or any combination thereof.

At a block 402, a value of the AC ripple voltage Vr is obtained while the fuel cell stack 100 is operating. As described above with reference to FIG. 2, the AC ripple voltage Vr may be sensed by the voltage sensor 212 for the fuel cell stack 100 and/or the voltage sensor 220 for individual or groups of fuel cells 102. The sensed value of the AC ripple voltage Vr may be peak-to-peak value or other value as described previously above.

At a block 404, a value of the AC ripple current Ir is obtained using the current sensor 216, for example. As described above, the obtained value can be a peak-to-peak value of the AC ripple current Ir or other value representative thereof. For the values obtained at the blocks 402 and 404, the conditioning electronics 214 and 218 or other signal processing circuitry may be used to provide the obtained values in a format that can be used by the controller 210.

At a block 406, the AC impedance is determined from the obtained AC ripple voltage Vr and the AC ripple current Ir values. In one embodiment, the controller 210 uses the lookup table 226 to directly locate an AC impedance entry that correlates to the obtained AC ripple voltage Vr and the AC ripple current Ir values. In another embodiment, the controller 210 can cooperate with the software 224 to calculate the real-time instantaneous, average, or other value of the AC impedance based on the obtained AC ripple voltage Vr and the AC ripple current Ir values.

In a further embodiment, Fourier analysis may be used to determine the AC impedance. In such an embodiment, the AC ripple voltage Vr is transformed into a series of sinusoidal components (i.e., a Fourier series). The fundamental component in the Fourier series and/or other harmonics are then used to reference a lookup table (such as the lookup table 226) having previously determined AC impedance data at purely sinusoidal frequencies.

In yet another embodiment, the controller 210 can determine some other characteristic of the fuel cell stack 100 at the block 406. For example, AC impedance can be used as a proxy for determining the temperature of the fuel cell stack 100. At a given hydration, lower impedance correlates to a higher temperature, for example.

At a block 408, the controller determines whether additional hydration or dehydration of the fuel cell(s) 102 in the fuel cell stack 100 is needed based on the determined AC impedance. For instance, if the determined AC impedance value is high, then that high value is indicative of insufficient hydration. If no change in hydration is needed at a block 410, then the process repeats at a block 412 for the next sensing cycle. The next sensing cycle can be defined to any appropriate interval, such as seconds, minutes, hours, days, etc.

However, if a change in hydration is determined to be needed at the block 410, then the lookup table 226 of one embodiment can provide the controller 210 with the amount of hydration that should be provided by the hydration system 228 at a block 414. Alternatively or additionally, the controller 210 can control the hydration system 228 at the block 414 to initiate and continue hydration of the fuel cell(s) 102, while the controller 210 constantly monitors the AC impedance, until the AC impedance attains a sufficient value.

Accordingly, the various embodiments described herein provide techniques for determining AC impedance of the fuel cell stack 100 (or other electrical response of other components in the system 200) using simpler and less equipment than existing techniques. For example, since the AC ripples already exist, no additional frequency generator is needed. Existing sensors for sensing current and voltage may be used for determining impedance. This simplicity leads to cost savings and increased reliability.

With the described embodiments, instantaneous impedance is available in real time. Large currents at full rated output values area available, which gives higher resolution for the AC impedance. Additionally, the AC impedance can be determined during regular operation of the fuel cell stack 100, and need not be performed solely at the manufacturing stage or require a shut down of the system 200.

The capability to perform in situ, real-time AC impedance checking allows constant system performance monitoring over a long service life, since the degradation of components in the system can be monitored and the operating parameters can be automatically adjusted accordingly based on the monitored characteristics of the components. For instance, embodiments have been described as correlating the high-frequency portion of an impedance spectrum (e.g., the real component) to membrane hydration. Another analysis can be performed to separate the various components of the impedance spectrum, which can be correlated to membrane resistance, kinetic losses, mass transport losses, or other characteristics. For instance, if mass transport losses become large, reactant flow rate can be increased to compensate. This type of fuel cell diagnosis can assist in regular maintenance of the system 200 and/or optimize conditions that improve performance and extend the lifetime of the system 200.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

The above description of illustrated embodiments, including what is described in the Abstract, is not intended to be exhaustive or to limit the invention to the precise forms disclosed. While specific embodiments and examples are described herein for illustrative purposes, various equivalent modifications are possible within the scope of the invention and can be made without deviating from the spirit and scope of the invention.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms of taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

As yet another example, the inverter 202 has been described in embodiments above a type of power transformation device that can be implemented in the fuel cell system 200. It is appreciated that in other embodiments, other types of power transformation devices may be implemented in the fuel cell system 200, and which may generate voltage ripple and/or current ripple that can be correlated to the impedance or other characteristic of the fuel cell stack 100. Examples of such other power transformation devices include, but are not limited to, DC/DC step up/down converters, AC/DC rectifiers, and the like.

These and other modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method, comprising:
obtaining a value of a ripple voltage caused at least in part by a power transformation device, the ripple voltage being superimposed on an output voltage provided from a fuel cell stack coupled to the power transformation device;
using the obtained value of the ripple voltage to determine a characteristic associated with at least one fuel cell in the fuel cell stack; and
determining a hydration state of the at least one fuel cell in the fuel cell stack based on the determined characteristic.

2. The method of claim 1 wherein using the obtained value of the ripple voltage to determine the characteristic associated with at least one fuel cell comprises using the obtained value of the ripple voltage to determine an impedance of the at least one fuel cell.

3. The method of claim 2, further comprising obtaining a value of a ripple current caused at least in part by the power transformation device, the ripple voltage being superimposed on an output current provided from the fuel cell stack, wherein using the obtained value of the ripple voltage to determine the impedance of the at least one fuel cell comprises determining the impedance based on the obtained values of the ripple voltage and ripple current.

4. The method of claim 2 wherein determining the impedance based on the obtained values of the ripple voltage and ripple current comprises determining the impedance using a lookup table.

5. The method of claim 2 wherein determining the impedance based on the obtained values of the ripple voltage and ripple current comprises determining the impedance by calculating the impedance from the obtained values of the ripple voltage and ripple current.

6. The method of claim 1, further comprising determining at least another characteristic associated with the at least one fuel cell based on the obtained value of the ripple voltage.

7. The method of claim 1 wherein obtaining the value of the ripple voltage comprises obtaining a peak-to-peak value of the ripple voltage.

8. The method of claim 1, further comprising controlling a hydration of the at least one fuel cell based on the determined hydration state.

9. An article of manufacture, comprising:
a machine-readable medium for a system comprising a power transformation device and at least one fuel cell in a fuel cell stack coupled to the power transformation device, the machine-readable medium comprising instructions stored thereon to cause a processor to determine a characteristic associated with the at least one fuel cell, by:
obtaining a value of a ripple voltage caused at least in part by the power transformation device, the ripple voltage being superimposed on an output voltage provided from the fuel cell stack coupled; and
using the obtained value of the ripple voltage to determine the characteristic associated with the at least one fuel cell in the fuel cell stack.

10. The article of manufacture of claim 9 wherein the machine-readable medium further comprises instructions stored thereon to cause the processor to determine a hydration state of the at least one fuel cell in the fuel cell stack based on the determined characteristic.

11. The article of manufacture of claim 10 wherein the instructions to cause the processor to determine the hydration state of the at least one fuel cell in the fuel cell stack based on the determined characteristic comprises instructions to determine the hydration state based on a determined impedance.

12. The article of manufacture of claim 11 wherein the machine-readable medium further comprises instructions stored thereon to cause the processor to obtain a value of a ripple current superimposed on an output current provided from the fuel cell stack, wherein the instructions to cause the processor to determine the hydration state based on the determined impedance comprise instructions to determine the impedance using the obtained values of the ripple voltage and the ripple current.

13. A system, comprising:
means for obtaining a value of a ripple voltage superimposed on an output voltage provided by an energy device;
means for using the obtained value of the ripple voltage to determine a characteristic associated with the energy device; and
means for determining a hydration state of the energy device based on the determined characteristic.

14. The system of claim 13 wherein the energy device comprises at least one fuel cell in a fuel cell stack.

15. The system of claim 13, further comprising means for obtaining a value of ripple current superimposed on an output current provided by the energy device.

16. The system of claim 15 wherein the means for using the obtained value of the ripple voltage to determine the characteristic associated with the energy device comprises means for using the obtained value of the ripple voltage in conjunction with the obtained value of the ripple current to determine an impedance of the energy device.

17. The system of claim 16, further comprising lookup table means for determining the impedance of the energy device using ripple voltage and ripple current values present in the lookup table means.

18. The system of claim 13, further comprising means for obtaining the output voltage from the energy device and for providing the output voltage to a load.

19. The system of claim 13, further comprising hydration control means for controlling hydration or dehydration to the energy device in response to the determined hydration state.

20. An apparatus, comprising:
a sensor to sense a ripple signal superimposed on an output from an energy device;
circuitry coupled to the sensor to generate a value indicative of the sensed ripple signal; and
a controller coupled to the circuitry to determine a characteristic of the energy device based on the value indicative of the sensed ripple signal.

21. The apparatus of claim 20 wherein the ripple signal comprises a ripple voltage superimposed on a voltage output from the energy device.

22. The apparatus of claim 20 wherein the energy device comprises at least one fuel cell in a fuel cell stack.

23. The apparatus of claim 22 wherein the at least one fuel cell comprises a solid polymer electrolyte fuel cell.

24. The apparatus of claim 20 wherein the characteristic of the energy device comprises an impedance of the energy device, and wherein the controller is operative to determine a hydration state of the energy device based on the impedance.

25. The apparatus of claim 24, further comprising a hydration control system coupled to the energy device and responsive to the controller to control hydration or dehydration to the energy device based on the determined hydration state.

26. The apparatus of claim 20 wherein the sensor to sense the ripple signal comprises a voltage sensor to sense a ripple voltage, the apparatus further comprising:
a current sensor to sense a current ripple superimposed on an output current provided by the energy device; and
other circuitry coupled to the current sensor to generate a value indicative of the sensed ripple current and being coupled to the controller to provide the value thereto,
wherein the controller is operative to use both the generated values of the ripple voltage and the ripple current to determine an impedance associated with the energy device.

27. The apparatus of claim 26, further comprising a storage unit coupled to the controller, the storage unit comprising a lookup table stored therein that is usable by the processor to determine the impedance based on stored values of either or both ripple voltage and ripple current.

28. The apparatus of claim 26, further comprising a storage unit coupled to the controller, the storage unit comprising software stored therein that is usable by the processor to calculate the impedance based generated values either or both the ripple voltage and the ripple current.
